(19) United States
(12) Patent Application Publication
(10) Pub. No.: US 2010/0304211 A1
(43) Pub. Date: Dec. 2, 2010

(54) CURRENT CONDUCTOR FOR A GALVANIC CELL

(76) Inventors: Guenter Eichinger, Altenstadt (DE); Michael Gnann, Deisenhofen (DE); Mykola Polyakov, Kamenz (DE); Juergen Hofmann, Kamenz (DE); Joerg Breu, Kamenz (DE)

Correspondence Address: WEINGARTEN, SCHURGIN, GAGNEBIN & LEBOVICI LLP, TEN POST OFFICE SQUARE, BOSTON, MA, 02109, US

(21) Appl. No.: 12/747,764

(22) PCT Filed: Dec. 8, 2008
(86) PCT No.: PCT/EP08/10397

§ 371 Date: Aug. 5, 2010

(30) Foreign Application Priority Data
Dec. 12, 2007 (DE) 10 2007 059 768.3

(51) Int. Cl. H01M 10/0525; H01B 5/00; H01M 2/14; H01M 2/06

(52) U.S. Cl. 429/179; 174/126.1; 429/246; 429/231.95

(57) ABSTRACT

Plate-shaped current conductor (12) for a galvanic cell, with a first surface (16) and a second surface (17), which essentially face each other, and are connected with each other via a first side surface (18) and a second side surface (19), characterized in that the plate-shaped current conductor has, in the area of the first and/or second side surface (18, 19), a segment, which has a thickness (d), which is reduced in regard to its cross section vis-à-vis the thickness (D) as defined by first and second surface (16, 17) of the current conductor, which segment extends at least substantially over a sealing area (14) of the current conductor.

The present invention relates to a current conductor for a galvanic cell, as well as a galvanic cell comprising such a current conductor.

Galvanic cells, such as lithium ion cells, comprise, in many cases, multiple alternatingly stacked electrodes and separating elements, wherein a current conductor is either formed or attached to each electrode. Such a stack is usually accommodated in a packaging, from which the current conductors protrude, wherein the protrusion of these current conductors is sealed by the packaging. Several of these cells can, for example, be included in a lithium ion accumulator.

Recently, lithium ion cells have been used increasingly in electric vehicles and in electric hybrid vehicles. In these cases, during charging and discharging processes, very high currents flow through the current collectors, which are connected to the electrodes. Based on a permanent current flow of about 200 A, the temperature of a current collector is not allowed to rise, for example, above 50° C., since this not only leads to a loss of energy but also reduces the reliability of the lithium ion cell.

The cross section of the current conductor can, for example, be increased to reduce the energy conversion into heat. However, the dimensions of a lithium ion cell are often pre-defined or limited, due to limited assembly space, so that the current conductor often cannot be made wider. For this reason, thicker current collectors need to be used in many cases.

The aim of the present invention is therefore to provide a current conductor for galvanic cells, which ensures secure and durable sealing, independently of its thickness.

This problem is solved by a plate-shaped current conductor for galvanic cells, comprising the features of claim 1. Advantageous embodiments and developments and of the invention are the subject of the dependent claims.

The plate-shaped current conductor for a galvanic cell has a first surface and a second surface, which essentially face each other, and are connected with each other via a first side surface and a second side surface.

According to the present invention, it is envisioned that the plate-shaped current conductor has; in the area of the first and/or second side surface, a segment, which has a thickness, which is reduced in regard to its cross section vis-à-vis the thickness as defined by the first and second surface of the current conductor, which segment extends at least substantially over a sealing area of the current conductor.

By creating a segment with a thickness that us reduced in regard to its cross section, in the area of at least one side surface of the current conductor, a safe and a stable sealing can be formed between the current conductor and an appropriate packaging, so that a reliable and durable sealing of the galvanic cell is possible.

In the present invention, the term “galvanic cell” refers to cells for batteries and primary cells, respectively, as well as, in particular, rechargeable batteries and secondary batteries or accumulators, respectively. Generally, the current conductor is an element, which is connected with an electrode (anode or cathode) of the galvanic cell, or which is integrally formed with it, connected to it, being made of an electrically conductive material, to lead the charging current to the electrode or to dissipate the discharging current from the electrode.

The current conductor is an essentially plate-shaped body with a first surface and a second surface, which essentially face each other and, for example, form the two largest side surfaces of the body in the case of a cuboidal-shaped current conductor, which usually is aligned in parallel to the main extension plane of the corresponding electrode. The first and second side surface essentially face each other and connect the first and the second surface of the current conductor. The two side surfaces, which are the remaining surfaces in case of a cuboidal-shaped current conductor, have no relevance for the present invention.

A thickness D is defined by the first and the second surface of the plate-shape current conductor. This thickness D is the essentially constant thickness of the current conductor between the two side surface areas, in case of essentially parallel side surfaces. In case of side surfaces, which are not in parallel to each other, the thickness D of the current conductor can also be the maximum thickness between the two side surface areas, or alternately, the average thickness between the two side surface areas. The segment of reduced thickness in regard to its cross section has a reduced thickness (d) in the area of the first and second side surface compared to the defined thickness D of the current conductor, which, for example, can be the minimum thickness over the entire area of the body of the current conductor. In the area of a side surface, generally, one or several such segments of reduced thickness can be envisioned, having the same or a different thickness.

The sealing area does not surround the entire surfaces and sides surfaces of the current conductor, but usually only a part of it, i.e. a vertical section of it. In a galvanic cell, the sealing area of the current conductor is aligned with an appropriate sealing area of a packaging, in order to produce a tight sealing between the two components.

Although the invention is exemplified below in more detail in regard to an essentially cuboidal-shaped current conductor, it is obvious, that the person skilled in the art may also define the surfaces for the plate-shaped current conductor for other geometric forms (for example: no parallel side surfaces, no rectangular-shaped surfaces etc.) in the sense explained above.

In one embodiment of the invention, the segment of reduced thickness extends over the area of the first and/or the second side surface, essentially over the entire height of the first or second side surface. In an alternative embodiment of the invention, the area of reduced thickness in the area of the first and/or second side surfaces only extends essentially over the sealing area of the current conductor.

In another embodiment of the invention, the segment of reduced thickness in the area of the first and/or the second side surface is realized by an area segment, which merges into the first and second surface. Alternatively, the segment of reduced thickness in the area of the first and/or the second side surface is realized by at least two area segments, which on one hand, merge into each other, and, on the other hand, merge into the first and the second surface.

In a further embodiment of the invention, the area segment(s) of the segment of reduced thickness in the area of the first and/or second side surface is/are realized as essentially flat surfaces. Alternatively, the area segment(s) of the segment of reduced thickness in the range of the first and/or the second side surface is/are realized as curved surfaces. In case of several area segments, these segments can alternatively also comprise area segments, which are realized as essentially flat surfaces, and area segments, which are realized as curved surfaces.

In case of curved area segments, these segments can be selected to be concave or convex, or partially concave and partially convex.

In a further embodiment of the invention, the area segment(s) of the segment of reduced thickness in the area of the first and/or second side surface is/are realized to be inclined relative to the first or the second surface, having an average inclination angle of approximately 15° to 40°, preferably of about 20° to about 30°.

Further, the area segment(s) of the segment of reduced thickness in the area of the first and/or second side surface can be optionally realized symmetrically or asymmetrically.

Analogously, the area of the first and the area of the second side surface can optionally be realized symmetrically or asymmetrically to each other.

In still a further embodiment of the invention, the transition regions between the area segments and the surfaces and/or the transition regions between several area segments are realized to be steady, i.e. continuous or with no edges. Alternatively, these transition regions can also be non-steady, i.e. with edges.

In one embodiment of the invention, the current conductor is provided with a sealing layer in the sealing area. In other words, the current conductor is pre-sealed.

In this case, the sealing layer encloses the first and second surface, as well as the first and the second side surface of the current conductor around the circumference. The sealing layer is preferably made of a plastic material such as polyethylene, polypropylene, polyimide, polyethylene terephthalate, PVC, PDFE or any combination thereof. The sealing layer has, for example, a thickness in the range of about 0.02 mm to about 0.3 mm, preferably from about 0.05 mm to about 0.2 mm.

The sealing area and the sealing layer have, for example, a width of approximately 4 mm to about 15 mm, preferably from about 6 mm to about 10 mm.

In principle, the current conductor described above can be used in a galvanic cells for both electrodes, i.e. for the anode and the cathode. Furthermore, the current conductor is particularly advantageous for galvanic cells, which comprise a stack of several first electrodes and several second electrodes, which are alternatingly stacked onto each other, and which are each separated by a separation element.

In a first embodiment of the galvanic cell, the first and the second electrode(s) are contained in a packaging, through which the first and the second current conductor protrude. The packaging comprises a sealing area, and the first and/or the second current conductor is realized as a pre-sealed current conductor, which is sealed with the packaging in the sealing area of these two components.

In a second embodiment of the galvanic cell, the first and the second electrode(s) as well as the separating element(s) are accommodated in a packaging out of which the first and second current conductor protrude, and which features a sealing area pre-sealed with a sealing layer and, moreover, the first and/or the second current conductor is/are realized as a current conductor without its own sealing layer, which is sealed via the sealing layer of the packaging in the sealing areas of these two components.

In a third embodiment of the galvanic cell, the first and the second electrode(s) as well as the separating element(s) are accommodated in a packaging, out of which the first and second current conductor protrude, and which features a sealing area without its own sealing, and, moreover, the first and/or second current conductor is/are realized as current conductors without its own sealing. In this case, the sealing between these two components is realized by a interposed, separate sealing layer, or, in case of an appropriate packaging material, directly between the two components.

Finally, in a fourth embodiment of the galvanic cell, the first and the second electrode(s) as well as the separating elements(s) are accommodated in a packaging out of which the first and the second current conductor protrude, and which features a sealing area, which is pre-sealed with a sealing layer and, moreover, the first and/or the second current conductor is/are realized as a pre-sealed current conductor sealed with the packaging in the sealing area of the current conductor via the sealing layer of the current conductor and via the sealing layer of the packaging.

It is of particular advantage to use of the current conductor according to the present invention in galvanic cells, which are realized as lithium ion cells.

Features and advantages of the invention as disclosed above and in the following are better understandable in the context of the following descriptions of preferred, non-limiting embodiments, in context with the attached figures, in which:

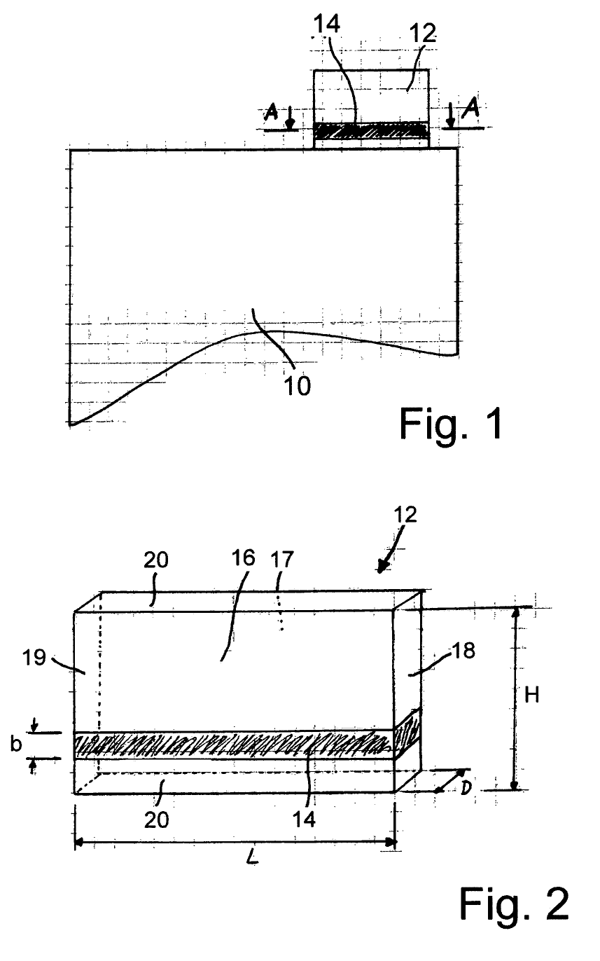

FIG. 1 is a highly simplified side view of an electrode of a galvanic cell with a current conductor of the present invention;

FIG. 2 is a highly schematic perspective view of the current conductor of the present invention with no sealing layer.

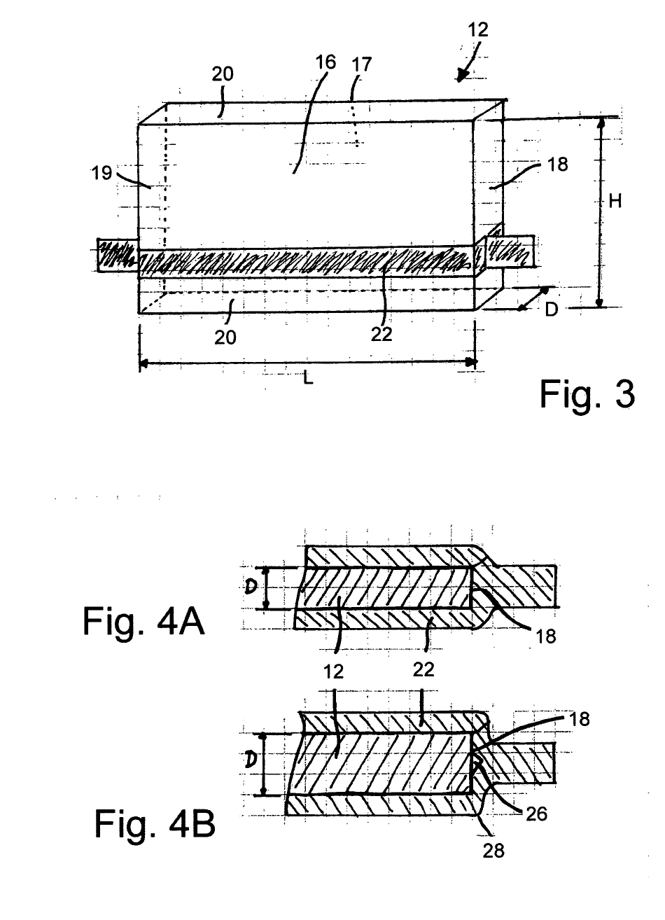

FIG. 3 is a highly schematic perspective view of the current conductor of the present invention with pre-sealing;

FIGS. 4A and 4B are two schematic partial views of conventional current conductors with a sealing layer according to section A-A in FIG. 1, to illustrate the underlying problem of the present invention;

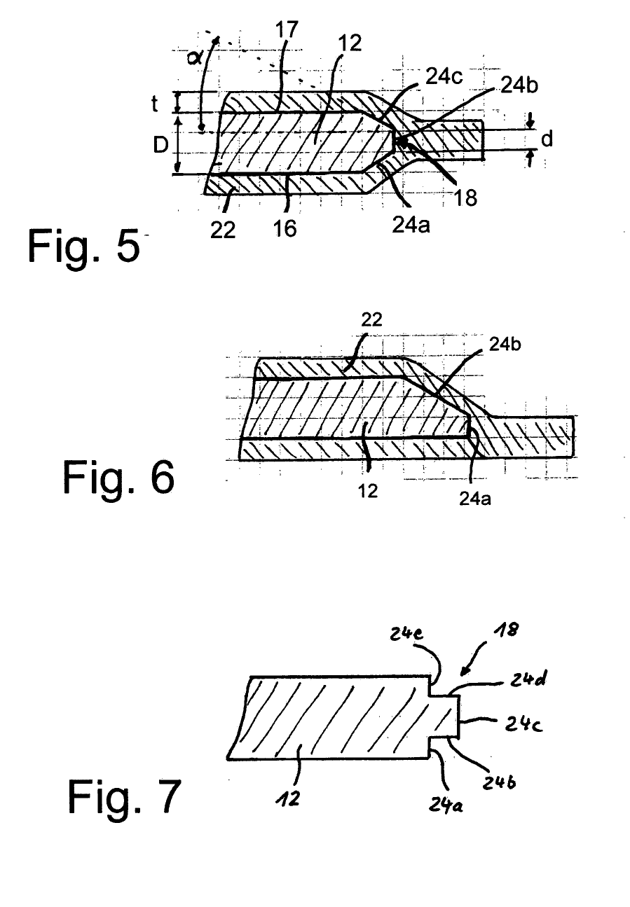

FIGS. 5 and 6 are schematic partial views of different embodiments of a current conductor with a sealing layer according to section A-A in FIG. 1; and

FIGS. 7 to 15 are schematic partial views of various additional embodiments of a current conductor (each without a sealing layer) according to section A-A in FIG. 1.

The basic structure of a current conductor according to the present invention is first described on the basis of FIGS. 1 to 3.

FIG. 1 shows an electrode (10) of a galvanic cell, for example of a lithium ion cell, with a current conductor (12). The current conductor (12) is either integral to the electrode (10) (in particular in the extension of the electrode collector) or attached to the electrode in an electrically conductive connection (in particular to the electrode collector).

The electrode (10) is a first electrode (anode) or a second electrode (cathode) of a galvanic cell. The current conductor (12) of the present invention, which is hereinafter described in detail is, in particular, advantageously applicable for lithium ion cells with a stack of several first electrodes and several second electrodes, which are alternatingly stacked onto each other, each separated from each other with a separating element, without limiting the present invention to only such galvanic cells. Generally, the current conductor of the present invention can be used for layered cells and wound cells, for primary cells and for secondary cells.

In a lithium ion cell, the current conductor, which is connected to the anode, is usually made of copper, and the current conductor, which is connected with the cathode, is usually made of aluminium. Evidently, however, the present invention is not limited to these materials and for other kinds of secondary or primary batteries, with other electrolytes and other electrodes, other materials may be preferred.

As indicated in FIG. 1, the current conductor (12) has a sealing area (14), with which the current conductor, protruding from a packaging of the cell (not depicted), is tightly sealed with the packaging.

FIG. 2 shows an enlarged perspective view of the current conductor (12) of FIG. 1 with the sealing area (14).

The essentially plate-shaped current conductor (12) is illustrated as a cuboid body, which comprises a first surface (16) and a second surface, (17), which are essentially—not necessarily in parallel—opposite to each other. The two surfaces 16 and 17 form the main surfaces of the current conductor (12) with the largest areas, and are essentially arranged in parallel to the main extension plane of the electrode (10), as indicated in FIG. 1. The two surfaces are represented by a first side surface (18) and a second side surface (19), which are essentially—not necessarily in parallel—opposite to each other.

The plate-shaped cuboid body, further comprises two additional side surfaces (20) (above and in FIG. 2), which connect the two surfaces (16, 17) with each other. They are used for electrical contact between the current conductor (12) and the electrode (10), or its electrode collector on one hand, and a connection of the galvanic cell on the other hand.

The current conductor (12) has a sealing area (14), with which the conductor is sealed tightly with the packaging of the galvanic cell. This sealing area encloses the first and second surface (16, 17) across the circumference, as well as the first and second side surfaces (18, 19), via a certain partial height (h), i.e. not over the entire height (H), of the current conductor (12).

Even if the sealing area (14) is essentially in parallel to the edges of the two surfaces (16, 17) and to the two side surfaces (18, 19), this is not mandatory, and the course of the sealing area (14) can also be adapted to the configuration of the cell packaging. The thickness (b) of the sealing area also does not have to be of constant thickness over the entire area of the current conductor, as depicted in FIG. 2.

FIG. 3 shows an enlarged perspective view of the current conductor (12) of FIG. 1 with a sealing layer (22) in a sealing area (14), i.e. a pre-sealed current conductor (12).

While the current conductor (12) in the embodiment of FIG. 2 only contains one sealing area (14) with which sealing of the packaging of the cell is achieved, in the embodiment of FIG. 3, a sealing layer (22) is added to the sealing area (14) of the current conductor. The sealing layer (22) is, for example, added in a thermal process to the current conductor in form of a sealing strip or a sealing film. Usually flags/tabs are formed in the area of the two side surfaces (18, 19) of the current conductor (12), where two sealing strips or sealing films (22) are directly joined together.

The seal layer (22) consists of a high-melting plastic material, which is chemically compatible and inert with respect to the content of the galvanic cell. Suitable materials for the sealing layer (22) include, for example, polyethylene, polypropylene, polyimide, polyethylene terephthalate, PVC, PDFE or any combination thereof. The sealing layer (22) has, for example, a thickness (t) in the range of about 0.02 mm to about 0.3 mm, preferably in the range of about 0.05 mm to about 0.2 mm, and most preferably from about 0.1 mm. The width of the sealing layer (22) essentially corresponds to the width (b) of the sealing area (14) of the current conductor (12).

The other characteristics of the current conductor (12) of embodiment FIG. 3 are the same as of the above-described embodiment of FIG. 2.

The current conductor (12) of FIG. 2 or 3, respectively, has a length (L), a height (H), and a thickness (D). The length (L) is defined by the distance between the two side surfaces (18, 19), the height (H) is defined by the distance of the two side surfaces (20), and the thickness (D) is defined by the distance between the two surfaces (16, 17). Therein, the thickness (D) of the current conductor, which is defined by the two surfaces (16, 17), can, for example, be the essentially constant thickness between its two side surface areas, in case the two surfaces (16, 17) are essentially in parallel to each other. In case of non-parallel side surfaces (16, 17), the thickness (D) of the current conductor (12) can also be defined as a maximum thickness between the two side area surfaces, or alternatively, be defined as an average thickness between the two side surface areas.

In an exemplified embodiment, the current conductor (12) consists of copper (for connecting the same to an anode) or aluminium (for connecting the same to a cathode) and has, for example, a thickness (D) of about 0.3 mm (copper), or about 0.5 mm (aluminium), respectively, a height (H) of about 35 mm and a length (L) of about 105 mm. The sealing area (14) or the sealing layer (15), respectively, have a width (b) of about 7 mm and can be added, for example, in a distance of about 50 to 10 mm from the lower edge of the current conductor (12).

The sealing between the current conductor (12) and the packaging of the galvanic cell can be achieved differently, depending on the embodiment of the current conductor (12). In a first embodiment, the current conductor (12) comprises only a sealing area (14), but no pre-sealed sealing layer (22). If the packaging of the galvanic cell also only comprises a sealing area, but no sealing layer, the sealing between the two components can either be accomplished via an intervening separate sealing layer, or—in case of an appropriate packaging material—directly.

In a second embodiment, the current conductor (12) again only comprises the sealing area (14) (see FIG. 2), but the corresponding sealing area of the packaging is pre-sealed with a sealing layer, so that the sealing between the current conductor (12) and the packaging can be accomplished by means of the sealing layer of the packaging.

Furthermore, in a third embodiment according to FIG. 3, the current conductor (12) is provided with a sealing layer (22) in sealing area (14). Therefore, the packaging of the galvanic cell does not require its own sealing layer in the sealing area, since the sealing is realized between the two components, onto the current conductor, by means of the pre-sealed sealing layer (22).

As another embodiment, it is also possible, to provide the sealing area (14) of the current conductor (12) with a sealing layer (22), as well as to provide the sealing area of the cell packaging with a sealing layer. In this case, the sealing is performed by means of the connection of the two sealing layers on the current conductor and on the packaging.

Referring to FIGS. 4A and 4B, in a first step, the drawbacks of conventional current conductors are illustrated, which have essentially a square-shape cross section.

FIG. 4A shows a relatively thin current conductor (12) with an average thickness (D) of a maximum of about 0.2 mm in the area of the sealing area (14), or the sealing layer (22), respectively. As seen in FIG. 4A, due to its small thickness, the sealing layer (22) also attaches well to the area of the side surface 18 (or 19) of the current conductor (12).

However, in case of a thicker current conductor (12), non-tight areas in form of continuous channels (26) may occur on both side surfaces (18, 19), as illustrated in FIG. 4B. The packaging of the galvanic cell, with which the current conductor (12) is sealed in this area, must support an essentially rectangular bend (28), which, of course, reduces the durability of the packaging in this location. These weak spots of the sealing lead to reduced safety and durability of the sealing, in particular during high charging currents and high discharging currents of the current conductor (12) and the associated high temperatures.

To reduce these types of problems for conventional current conductors, it is suggested to modify the current conductor (12) for galvanic cells. Subsequently, in reference to FIGS. 5 to 15, various embodiments of a current conductor (12) will be described in more detail. In principle, all illustrated current conductors (12) can be realized with or without a pre-sealed sealing layer, while not illustrating both embodiments.

In a first embodiment of FIG. 5, a total of three area segments (24a, 24b, 24c) are intended in the area of the side surface (18). All three area segments (24a, 24b, 24c) are realized essentially as flat surfaces, whereas the first and the third area segment (24a, 24c) each merge, on one hand, into the neighbouring surface (16, 17), and, on the other hand, merge into the second area segment (24b). The transitions between the area segments (24a, 24b, 24c) with respect to each other and to the surfaces (16, 17) are, in this example, non-steady, i.e. formed by means of edges (however, each forming a blunt angle of more than 90°). Alternatively, these transitions can also be steady, i.e. rounded, or realized as a continuous transition.

A segment of reduced thickness is realized in the area of the side surface (19) of the current conductor by means of these three area segments (24a, 24b, 24c). The thickness (d) of the segment is reduced in cross section compared to the thickness (D) of the current conductor (12) between the two side surfaces (18, 19). As clearly illustrated in FIG. 5, in this configuration of the current conductor (12), the sealing layer (22) can be attached tightly and safely to the side surfaces (18, 19), even while a larger thickness (D) of the current conductor (12) prevails. The stability and the durability of the packaging is also improved, since the packaging is not strongly bent in the area of the side surfaces (18, 19).

In the embodiment of FIG. 5, the reduced thickness (d) is, at the same time, the minimum thickness of the entire current conductor (12), and, as illustrated in FIG. 5, this thickness is also present at the very border area of the side surface (18).

The two area segments (24a and 24c) are inclined, with a mean inclination angle (α), with respect to the respective surface (16 or 17). This inclination angle (α) is, for example, in the range of about 15° to about 40°, preferably from about 20° to about 30°, most preferably at about 30°. Although the two area segments (24a, 24c) are both illustrated in FIG. 5 as having the same inclination angle (α), it is of course possible to realize the two area segments (24a, 24c) with different inclination angles (α) in the area of the side surface (18).

The second embodiment of FIG. 6 differs from the above first embodiment in that the area of the side surface (18) is not realized symmetrically in cross section, but asymmetrically.

Specifically, the segment of reduced thickness (d) is realized, in the area of the side surface (18), via two area segments (24a, 24b), which each are realized as flat surfaces and merge non-steadily into the surfaces (16, 17), and into each other.

The third embodiment, shown in FIG. 7, differs from the above first embodiment in that the segment of reduced thickness in the area of the side surface (18) is realized via a total of five and not of three area segments (24a to 24e), which each enclose an essentially right angle in respect to each other. The reduced thickness (d) of the segment of reduced thickness is thus defined between the two area segments (24b and 24d).

As an asymmetric alternative of this embodiment, it is also possible to replace the two area segments (24d, 24e) in FIG. 7 with the third surface section 24c of FIG. 5.

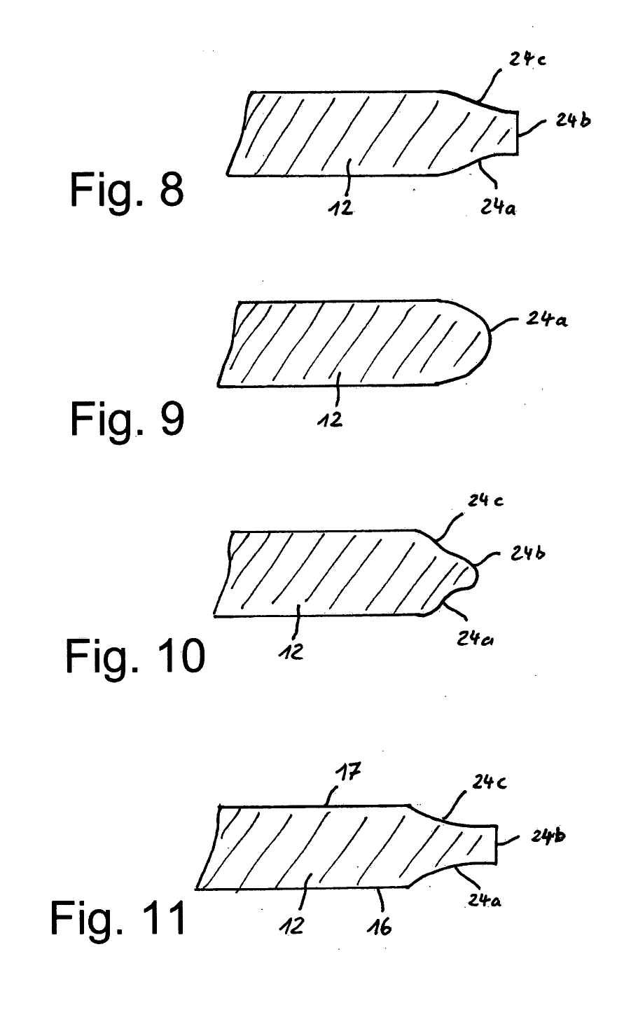

The fourth embodiment, illustrated in FIG. 8, differs from the above-described first embodiment in that the first and second area segments (24a, 24c), which form the segment of reduced thickness in the area of the side surface (18), are not realized as flat surfaces, but each as curved surfaces. The two curved surfaces each comprise an area with a convexly curved surface and an area with a concavely curved surface, which merge steadily into each other. Moreover, the two area segments (24a and 24c) merge steadily into the two surfaces (16, 17) of the current conductor, and non-steadily into the second area segment (24b). Alternatively, the fusion regions can also be steadily, i.e. rounded, between the first and the third area segment (24a, 24c) and the second area segment (24b).

As an asymmetric alternative of this embodiment, it is also possible, for example, to replace the curved third area segment (24c) of FIG. 8 with the flat third area segment (24c) of FIG. 5.

In the fifth embodiment of FIG. 9, only one area segment (24c) is provided in the area of the side surface (18), the latter is, therefore, convexly curved. Different curvature radii, as well as a constant curvature radius, are possible for the area segment.

The sixth embodiment, illustrated in FIG. 10, can be seen as a combination of the above-described forth and fifth embodiments. Based on the forth embodiment of FIG. 8, in which the first and the third area segments (24a, 24c) are realized as curved surfaces, the second area segment (24b) is realized in the present embodiment not as a flat surface (FIG. 8), but as a convexly curved surface (FIG. 9).

The seventh embodiment, which will now be described in the context of FIG. 11, may be regarded as a variant of the first embodiment of FIG. 5, or as a variant of the fourth embodiment of FIG. 8. In particular, the segment of reduced thickness is realized, in the area of the side surface (18), via a total of three area segments (24a, 24b, 24c) in an essentially symmetrical form in regard to its cross section. While the second area segment (24b) is realized as a flat surface, the two bordering area segments (24a, 24c) are realized as concavely curved surfaces. The transition regions between the area segments (24a, 24b, 24c) and the surfaces (16, 17) are each intended to be non-steadily, i.e. with the formation of edges.

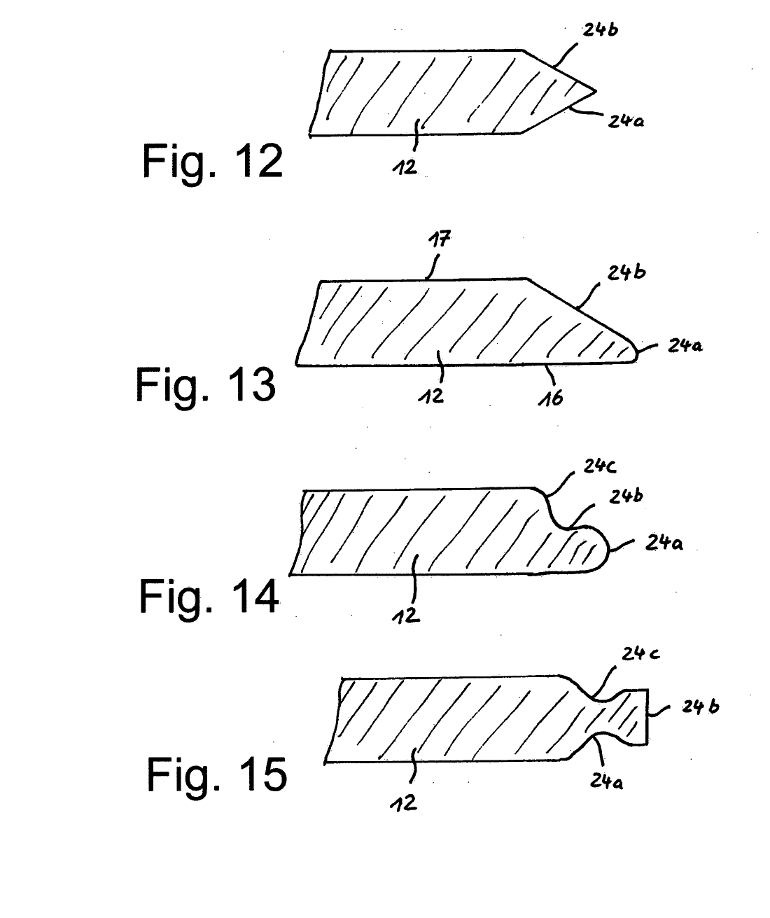

In the eighth embodiment of FIG. 12, the segment of reduced thickness in the area of the side surface (18) of the plate-shaped current conductor (12) is realized via two area segments (24a, 24b), which each are realized as flat surfaces, and each merge essentially triangularly into each other in regard to their cross section. Departing from this embodiment of symmetrical side surfaces (18), it is also possible to incline the two area segments (24a, 24b) to the respective surfaces (16, 17) with different inclination angles (α).

The ninth embodiment, illustrated in FIG. 13, is a modification of the above-described second embodiment of FIG. 6. As in the second embodiment, an asymmetrical configuration of the area of the side surface (18) is also intended for the ninth embodiment. The segment of reduced thickness is realized via a first area segment (24a), which is realized as a convexly curved surface, and a second area segment (24b), which is realized as an essentially flat area segment (24a). The transition regions between the first area segment (24a) and the first surface (16) as well as the second area segment (24b) are steadily formed, whereas the transition region between the second area segment (24b) and the second surface (17) of the current conductor is non-steadily formed.

As a tenth embodiment, FIG. 14 illustrates a current conductor (12), with a cross section in asymmetric configuration, in the area of the side surface (18). To form the segment of reduced thickness, three area segments (24a, 24b, 24c) are provided, which each are realized as curved surfaces, and which are each provided with steady transitions to the surfaces (16, 17) of the current conductor, as wells as between each other. The first and the third area segment (24a, 24c) are each formed as convex surfaces, and the second area segment (24b), which is arranged in between, is formed as a concave surface. Therein, optionally, by means of the second area segment (24b), a constriction in cross section can be formed, so that the minimum thickness of the segment of reduced thickness does not lie at the very edge of the current conductor (12), in contrast to the above illustrated embodiments.

The eleventh embodiment, illustrated in FIG. 15, has an essentially symmetrical configuration in the area of the side surfaces (18) of the current conductor (12), in regard to its cross section. As a variation of the embodiment of FIG. 8, the first and the third area segments (24a, 24b) are realized as multiply curved surfaces, so that a two-sided constriction is established in cross section, as seen in FIG. 15. The second area segment (24b), which is arranged between the two area segments (24a, 24c), is realized as an essentially flat surface. In an alternative embodiment, the constriction in the segment of reduced thickness can also be provided only on one side.

The present invention has been described in detail above, exemplified by numerous embodiments of the current conductor (12). However, it is obvious that the person skilled in the art will find additional variations and modifications of the present invention, based on the illustrated embodiments, without departing the from scope of protection, defined by the attached claims.

In particular, the embodiments of the current conductor (12), as illustrated in FIGS. 5 to 15, can be combined with each other in any order. In this sense, only two or more than two configurations can be combined with each other.

The cross-sectional configurations of the current conductor (12), illustrated in FIGS. 5 to 15, extend at least essentially across the partial height (b) of the sealing layer (14) of the current conductor. To simplify the manufacturing of the current conductor (12) of the present invention, it can be advantageous to provide the illustrated cross-sectional configurations over the entire height (H) of the current conductor (12).

FIGS. 5 to 15 each illustrate just the area close to one side surface (19) of the current conductor (12). Of course, also the other side surface (18) may preferably be provided with a cross-sectional configuration, which comprises a segment of reduced thickness (d) in comparison to thickness (D) of the current conductor (12). The two side surface areas can optionally be symmetrical, i.e. each with the same cross-sectional configurations, or asymmetrical, i.e. with different configurations, wherein any combination of FIGS. 5 to 15 as well as others, are possible.

The mean inclination angle (α) in the area of the side surface (18, 19), which is illustrated by means of embodiment of FIG. 5, also applies to all other illustrated embodiments, i.e. also for those with area segments and curved surfaces.

Due to the outlined advantages, the current conductor configured according to the present invention is particularly suitable for lithium ion cells, for example for electrical vehicles and for electrical hybrid vehicles, for which thicker current conductors must be used, due to the arising strong currents.

1. Plate-shaped current conductor for a galvanic cell, with a first surface and a second surface, which essentially face each other, and are connected with each other via a first side surface and a second side surface, characterized in that the plate-shaped current conductor has, in the area of the first and/or second side surface, a segment, which has a thickness (d), which is reduced in regard to its cross section vis-à-vis the thickness (D) as defined by first and second surface of the current conductor, which segment extends at least substantially over a sealing area of the current conductor.

2. Current conductor according to claim 1, characterized in that the segment of reduced thickness (d) in the area of the first and/or the second side surface extends essentially over the entire height of the first or second side surface, respectively.

3. Current conductor according to claim 1, characterized in that the segment of reduced thickness (d) in the area of the first and/or the second side surface extends essentially over the sealing area of the current conductor.

4. Current conductor according to claim 1, characterized in that the segment of reduced thickness (d) in the area of the first and/or the second side surface is formed by at least one area segment which merges into the first and the second surface.

5. Current conductor according to claim 1, characterized in that the segment of reduced thickness (d) in the area of the first and/or the second side surface is formed by at least two area segments, which, on the one hand, merge into each other and, on the other hand, merge into the first and into the second surface.

6. Current conductor according to claim 4, characterized in that the area segment(s) of the segment of reduced thickness (d) in the area of the first and/or the second side surface is/are realized as an essentially flat surface.

7. Current conductor according to claim 4, characterized in that the area segment(s) of the segment of reduced thickness (d) in the area of the first and/or the second side surface is/are realized as curved surface(s).

8. Current conductor according to claim 5, characterized in that the area segment(s) of the segment of reduced thickness (d) in the area of the first and/or the second side surface comprise area segment(s), which is/are realized as essentially flat surface(s), and area segment(s), which is/are realized as curved surface(s).

9. Current conductor according to claim 7, characterized in that the curved surface(s) is/are realized as concavely curved surface(s).

10. Current conductor according to claim 7, characterized in that the curved surface(s) is/are realized as convexly curved surface(s).

11. Current conductor according to claim 7, characterized in that the curved surface(s) is/are realized as partially concavely and partially convexly curved surface(s).

12. Current conductor according to claim 4, characterized in that the area segment(s) of the segment of reduced thickness (d) in the area of the first and/or the second side surface is/are realized to be inclined relative to the first or the second surface, having an average inclination angle (α) of approximately 15° to 40°.

13. Current conductor according to claim 12, characterized in that the area segment(s) of the segment of reduced thickness (d) in the area of the first and/or the second side surface is/are realized to be inclined relative to the first or the second surface, having an average inclination angle (α) of approximately 20° to 30°.

14. Current conductor according to claim 1, characterized in that the segment of reduced thickness (d) in the area of the first and/or the second side surface is realized to have an essentially symmetrical cross section.

15. Current conductor according to claim 1, characterized in that the segment of reduced thickness (d) in the area of the first and/or the second side surface is realized to have an essentially asymmetrical cross section.

16. Current conductor according to claim 1, characterized in that the area of the first side surface and the area of the second side surface are realized to be essentially symmetrical to each other in regard to their cross section.

17. Current conductor according to claim 1, characterized in that the area of the first side surface and the area of the second side surface are realized to be essentially asymmetrical to each other in regard to their cross section.

18. Current conductor according to claim 1, characterized in that the transition regions between the area segments and the surfaces and/or the transition regions between several area segments are realized to be steady in regard to their cross section.

19. Current conductor according to claim 1, characterized in that the transition regions between the area segments and the surfaces and/or the transition regions between several area segments are realized to be non-steady in regard to their cross section.

20. Current conductor according to claim 1, characterized in that the current conductor is provided with a sealing layer in the sealing area.

21. Current conductor according to claim 20, characterized in that the sealing layer encloses the first and the second surface and the first and second side surface of the current conductor around the circumference.

22. Current conductor according to claim 20, characterized in that the sealing layer is made of plastic.

23. Current conductor according to claim 22, characterized in that the sealing layer is made of polyethylene, polypropylene, polyimide, polyethylene terephthalate, PVC, PDFE, or any combination thereof.

24. Current conductor according to claim 20, characterized in that the sealing layer has a thickness (t) in the range of about 0.02 mm to about 0.3 mm.

25. Current conductor according to claim 24, characterized in that the sealing layer has a thickness (t) in the range of about 0.05 mm to about 0.2 mm.

26. Current conductor according to claim 20, characterized in that the sealing area or the sealing layer, respectively, have a width (b) in the range of about 4 mm to about 15 mm.

27. Current conductor of claim 26, characterized in that the sealing area or the sealing layer, respectively, have a width (b) in the range of about 6 mm to about 10 mm.

28. Galvanic cell, with a first electrode to which a first current conductor is attached, a second electrode to which a second current conductor is attached, and a separating element arranged between the first and second electrodes, characterized in that the first and/or the second current conductor is a current conductor according to claim 1.

29. Galvanic cell according to claim 28, characterized in that the galvanic cell comprises a stack of several first electrodes and of several second electrodes, which are alternately stacked onto each other and each separated by a separating element.

30. Galvanic cell according to claim 28, characterized in that:
the first and the second electrode(s), as well as the separating element(s) are contained in a packaging, through which the first and the second current conductors protrude, and which exhibits a sealing area; and
the first and/or the second current conductor is realized as a current conductor according to claim 20, and is/are sealed with the packaging via the sealing layer in the sealing area of the current conductor and of the packaging.

31. Galvanic cell according to claim 28, characterized in that:
the first and the second electrode(s) and the separating element(s) are contained in a packaging, through which the first and second current conductors protrude, and which features a sealing area which is pre-sealed with a sealing layer; and
the first and/or the second current conductor is/are realized as a current conductor according to claim 1 and is/are sealed with the packaging via the sealing layer in the sealing area of the current conductor and the packaging.

32. Galvanic cell according to claim 28, characterized in that:
the first and the second electrode(s) and the separating element(s) are contained in a packaging, through which the first and second current conductors protrude, and which features a sealing area; and
the first and/or the second current conductor is/are realized as a current conductor according to claim 1 and is/are sealed with the packaging directly or via an interposed sealing layer in the sealing areas of the current conductors and the packaging.

33. Galvanic cell according to claim 28, characterized in that:
the first and the second electrode(s) and the separating element(s) are contained within a packaging, through which the first and second current conductors protrude, and which features a sealing area, which is pre-sealed with a sealing layer; and
the first and/or the second current conductor is/are realized as a current conductor according to claim 20 and is/are sealed with the packaging via the sealing layer of the current conductor and via the sealing layer of the packaging, in the sealing area of the current conductor and the packaging.

34. Galvanic cell according to claim 28, characterized in that the galvanic cell is a lithium ion cell.

35. Current conductor according to claim 20, characterized in that:
the sealing layer encloses the first and the second surface and the first and second side surface of the current conductor around the circumference;
the sealing layer is made of plastic;
the sealing layer is made of polyethylene, polypropylene, polyimide, polyethylene terephthalate, PVC, PDFE, or any combination thereof;
the sealing layer has a thickness (t) in the range of about 0.05 mm to about 0.2 mm;
the sealing area or the sealing layer, respectively, have a width (b) in the range of about 6 mm to about 10 mm; and
the segment of reduced thickness (d) in the area of the first and/or the second side surface is formed by at least one area segment which merges into the first and the second surface.

36. Current conductor according to claim 35, characterized in that:
the area segment(s) of the segment of reduced thickness (d) in the area of the first and/or the second side surface is/are realized as an essentially flat surface, or as essentially flat surface(s) and as curved surface(s); and
the area segment(s) of the segment of reduced thickness (d) in the area of the first and/or the second side surface is/are realized to be inclined relative to the first or the second surface, having an average inclination angle (α) of approximately 20° to 30°.

37. Current conductor according to claim 35, characterized in that:
the area segment(s) of the segment of reduced thickness (d) in the area of the first and/or the second side surface is/are realized as curved surface(s), or as essentially flat surface(s) and as curved surface(s); and
the curved surface(s) is/are realized as at least one of concavely curved surface(s); convexly curved surface(s); and partially concavely and partially convexly curved surface(s).

38. Galvanic cell according to claim 29, characterized in that:
the galvanic cell is a lithium ion cell;
the first and the second electrode(s) and the separating element(s) are contained within a packaging, through which the first and second current conductors protrude, and which features a sealing area, which is pre-sealed with a sealing layer; and
the first and/or the second current conductor is/are sealed with the packaging via the sealing layer of the current conductor and via the sealing layer of the packaging, in the sealing area of the current conductor and the packaging.
